(19) United States
(12) Patent Application Publication
(10) Pub. No.: US 2022/0124337 A1
(43) Pub. Date: Apr. 21, 2022

(54) HARMONIZATION OF INTRA TRANSFORM CODING AND WIDE ANGLE INTRA PREDICTION

(71) Applicant: INTERDIGITAL VC HOLDINGS, INC., Wilmington, DE (US)

(72) Inventors: Karam NASER, Mouaze (FR); Fabien RACAPE, San Francisco, CA (US); Gagan RATH, Bhubaneswar (IN)

(21) Appl. No.: 17/277,773

(22) PCT Filed: Sep. 19, 2019
(86) PCT No.: PCT/US2019/051943

§ 371 Date: Mar. 19, 2021

(30) Foreign Application Priority Data
Sep. 21, 2018 (EP) 18290102.5

(51) Int. Cl. H04N 19/132; H04N 19/105; H04N 19/159; H04N 19/176

(52) U.S. Cl. CPC H04N 19/132; H04N 19/176; H04N 19/159; H04N 19/105

(57) ABSTRACT

Methods and apparatus for using wide-angle intra prediction with position dependent intra prediction combination. Wide-angle intra prediction enables intra prediction direction angles higher than the conventional 45 degrees. Also, position dependent intra prediction combination (PDPC) was adopted in a specification for the next generation of video coding H.266/VVC and enables more reference pixels along edges of a block. In one embodiment, when a video block to be coded or decoded is non-square, additional intra prediction directions are enabled in the direction of the longer block edge. An index is used to indicate the prediction direction and can be adapted according to the additional intra predictions in the longer direction, with correspondingly fewer prediction directions along the shorter block edge. This preserves the number of prediction modes that need to be indexed but allows their angles to correspond to the shape of the block.

### TECHNICAL FIELD

At least one of the present embodiments generally relates to a method or an apparatus for video encoding or decoding, compression or decompression.

### BACKGROUND

To achieve high compression efficiency, image and video coding schemes usually employ prediction, including motion vector prediction, and transform to leverage spatial and temporal redundancy in the video content. Generally, intra or inter prediction is used to exploit the intra or inter frame correlation, then the differences between the original image and the predicted image, often denoted as prediction errors or prediction residuals, are transformed, quantized, and entropy coded. To reconstruct the video, the compressed data are decoded by inverse processes corresponding to the entropy coding, quantization, transform, and prediction.

In the development of the Versatile Video Coding (VVC) standard, block shapes can be rectangular. The rectangular blocks lead to wide angle intra prediction modes.

### SUMMARY

At least one of the present embodiments generally relates to a method or an apparatus for video encoding or decoding, and more particularly, to a method or an apparatus for interaction between max transform size and transform coding tools in a video encoder or a video decoder.

According to a first aspect, there is provided a method. The method comprises steps for predicting a sample of a rectangular video block using at least one of N reference samples from a row above the rectangular video block or at least one of M reference samples from a column left of the rectangular video block, wherein a number of wide angles is increased in proportion to an aspect ratio of the rectangular block, wherein if a prediction mode for the rectangular video block is set to exceed a maximum prediction angle, a prediction mode is used corresponding to that maximum prediction angle; and, encoding the rectangular video block using said prediction in an intra coding mode.

According to a second aspect, there is provided a method. The method comprises steps for predicting a sample of a rectangular video block using at least one of N reference samples from a row above the rectangular video block or at least one of M reference samples from a column left of the rectangular video block, wherein a number of wide angles is increased in proportion to an aspect ratio of the rectangular block, wherein if a prediction mode for the rectangular video block is set to exceed a maximum prediction angle, a prediction mode is used corresponding to that maximum prediction angle; and, decoding the rectangular video block using said prediction in an intra coding mode.

According to another aspect, there is provided an apparatus. The apparatus comprises a processor. The processor can be configured to encode a block of a video or decode a bitstream by executing any of the aforementioned methods.

According to another general aspect of at least one embodiment, there is provided a device comprising an apparatus according to any of the decoding embodiments; and at least one of (i) an antenna configured to receive a signal, the signal including the video block, (ii) a band limiter configured to limit the received signal to a band of frequencies that includes the video block, or (iii) a display configured to display an output representative of a video block.

According to another general aspect of at least one embodiment, there is provided a non-transitory computer readable medium containing data content generated according to any of the described encoding embodiments or variants.

According to another general aspect of at least one embodiment, there is provided a signal comprising video data generated according to any of the described encoding embodiments or variants.

According to another general aspect of at least one embodiment, a bitstream is formatted to include data content generated according to any of the described encoding embodiments or variants.

According to another general aspect of at least one embodiment, there is provided a computer program product comprising instructions which, when the program is executed by a computer, cause the computer to carry out any of the described decoding embodiments or variants.

These and other aspects, features and advantages of the general aspects will become apparent from the following detailed description of exemplary embodiments, which is to be read in connection with the accompanying drawings.

### BRIEF DESCRIPTION OF THE DRAWINGS

FIG. 1 shows an example of replacement of intra directions in a case of a flat rectangle with width greater than height, where 2 modes (#2 and #3) are replaced by wide angle modes (35 and 36).

FIG. 2 shows a standard, generic, video compression scheme.

FIG. 3 shows a standard, generic, video decompression scheme.

FIG. 4 shows an example processor-based subsystem for implementation of general described aspects.

FIG. 5 shows one embodiment of a method under the described aspects.

FIG. 6 shows another embodiment of a method under the described aspects.

FIG. 7 shows an example apparatus under the described aspects.

### DETAILED DESCRIPTION

At least one of the present embodiments generally relates to a method or an apparatus for video encoding or decoding, and video compression, more specifically the part related to transform coding of intra prediction residuals where the enhanced multiple transforms and/or secondary transforms are used in combination with the wide angle intra prediction.

To achieve high compression efficiency, image and video coding schemes usually employ prediction, including motion vector prediction, and transform to leverage spatial and temporal redundancy in the video content. Generally, intra or inter prediction is used to exploit the intra or inter frame correlation, then the differences between the original image and the predicted image, often denoted as prediction errors or prediction residuals, are transformed, quantized, and entropy coded. To reconstruct the video, the compressed data are decoded by inverse processes corresponding to the entropy coding, quantization, transform, and prediction.

The embodiments described here are in the field of video compression and relate to video compression and video encoding and decoding.

In the HEVC (High Efficiency Video Coding, ISO/IEC 23008-2, ITU-T H.265) video compression standard, motion compensated temporal prediction is employed to exploit the redundancy that exists between successive pictures of a video.

To do so, a motion vector is associated to each prediction unit (PU). Each Coding Tree Unit (CTU) is represented by a Coding Tree in the compressed domain. This is a quad-tree division of the CTU, where each leaf is called a Coding Unit (CU).

Each CU is then given some Intra or Inter prediction parameters (Prediction Info). To do so, it is spatially partitioned into one or more Prediction Units (PUs), each PU being assigned some prediction information. The Intra or Inter coding mode is assigned on the CU level.

In the JVET (Joint Video Exploration Team) proposal for a new video compression standard, known as Joint Exploration Model (JEM), it has been proposed to accept a quadtree-binary tree (QTBT) block partitioning structure due to high compression performance. A block in a binary tree (BT) can be split in two equal sized sub-blocks by splitting it either horizontally or vertically in the middle. Consequently, a BT block can have a rectangular shape with unequal width and height unlike the blocks in a QT where the blocks have always square shape with equal height and width. In HEVC, the angular intra prediction directions were defined from 45 degree to −135 degree over a 180 angle, and they have been maintained in JEM, which has made the definition of angular directions independent of the target block shape.

To encode these blocks, Intra Prediction is used to provide an estimated version of the block using previously reconstructed neighbor samples. The difference between the source block and the prediction is then encoded. In the above classical codecs, a single line of reference sample is used at the left and at the top of the current block.

In a recent work, wide-angle intra prediction was proposed, which enable intra prediction direction angles higher than the conventional 45 degrees. Also, position dependent intra prediction combination (PDPC) was adopted in the current specification for the next generation of video coding H.266/VC.

In the JVET (Joint Video Exploration Team) proposal for a new video compression standard, known as Joint Exploration Model (JEM), it has been proposed to accept a quadtree-binary tree (QTBT) block partitioning structure due to high compression performance. A block in a binary tree (BT) can be split in two equal sized sub-blocks by splitting it either horizontally or vertically in the middle. Consequently, a BT block can have a rectangular shape with unequal width and height unlike the blocks in a Quad Tree (QT) where the blocks have always square shape with equal height and width. In HEVC, the angular intra prediction directions were defined from 45 degree to −135 degree over a 180 angle, and they have been maintained in JEM, which has made the definition of angular directions independent of the target block shape. However, since the idea of partitioning a Coding Tree Unit (CTU) into CUs is to capture objects or parts of objects, and the shape of a block is associated with the directionality of objects, for higher compression efficiency, it is meaningful to adapt the defined prediction directions according to the block shape. In this context, the described general aspects propose to redefine the intra prediction directions for rectangular target blocks.

In HEVC (High Efficiency Video Coding, H.265), encoding of a frame of video sequence is based on a quadtree (QT) block partitioning structure. A frame is divided into square coding tree units (CTUs) which all undergo quadtree based splitting to multiple coding units (CUs) based on rate-distortion (RD) criteria. Each CU is either intra-predicted, that is, it is spatially predicted from the causal neighbor CUs, or inter-predicted, that is, it is temporally predicted from reference frames already decoded. In I-slices all CUs are intra-predicted, whereas in P and B slices the CUs can be both intra- or inter-predicted. For intra prediction, HEVC defines 35 prediction modes which includes one planar mode (indexed as mode 0), one DC mode (indexed as mode 1) and 33 angular modes (indexed as modes 2-34). The angular modes are associated with prediction directions ranging from 45 degree to −135 degree in the clockwise direction. Since HEVC supports a quadtree (QT) block partitioning structure, all prediction units (PUs) have square shapes. Hence the definition of the prediction angles from 45 degree to −135 degree is justified from the perspective of a PU (Prediction Unit) shape. For a target prediction unit of size N×N pixels, the top reference array and the left reference array are each of size 2N+1 samples, which is required to cover the aforementioned angle range for all target pixels. Considering that the height and width of a PU are of equal length, the equality of lengths of two reference arrays also makes sense.

For the next video coding standard, JVET's attempt as Joint Exploration Model (JEM) proposes to use 65 angular intra prediction modes in addition to the planar and DC modes. However, the prediction directions are defined over the same angular range, that is, from 45 degree to −135 degree in clockwise direction. For a target block of size W×H pixels, the top reference array and the left reference array are each of size (W+H+1) pixels, which is required to cover the afore-mentioned angle range for all target pixels. This definition of the angle in JEM was done more for simplicity than for any other specific reason. However, in doing so, some inefficiency was introduced.

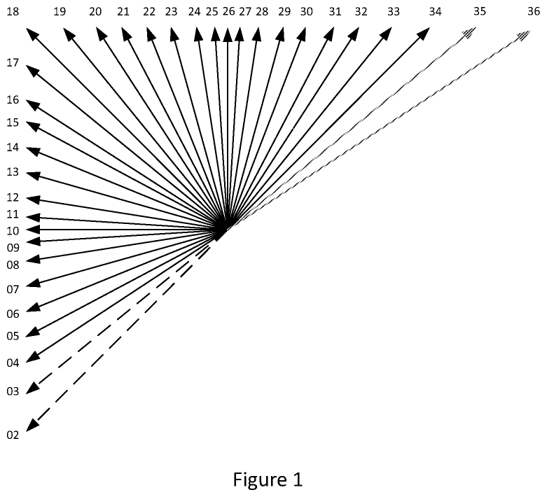

FIG. 1 shows an example of how angular intra modes are replaced with wide angular modes for non-square blocks in the case of 35 intra directional modes. In this example, mode 2 and mode 3 are replaced with wide angle mode 35 and mode 36, where the direction of mode 35 is pointing to the opposite direction of mode 3, and the direction of mode 36 is pointing to the opposite direction of mode 4.

FIG. 1 shows replacing intra directions in the case of a flat rectangle (width>height). In this example, 2 modes (#2 and #3) are replaced by wide angle modes (35 and 36).

For the case of 65 intra directional modes, wide angle intra prediction can transfer up to 10 modes. If a block has greater width than height, for example, modes #2 to mode #11 are removed and modes #67 to #76 are added under the general embodiments described herein.

PDPC, as currently adopted in the draft for a future standard H.266/VVC, applies to several intra modes: planar, DC, horizontal, vertical, diagonal modes and so called adjacent diagonal modes, i.e. close directions to the diagonals. In the example of FIG. 1, diagonal modes correspond to mode 2 and 34. Adjacent modes can include for instance modes 3, 4, 32, 33 if two adjacent modes are added per diagonal direction. In the current design of the adopted PDPC, 8 modes are considered per diagonal, i.e. 16 adjacent diagonal mode in total. PDPC for diagonal and adjacent diagonal modes is detailed below.

Wide Angle Intra Prediction (WAIP) has recently been adopted in the current test model for Versatile Video Coding VVC (H.266), expected to be the successor of H.265/HEVC. WAIP basically adapts the range of intra directional modes to better fit the shape of a rectangular target block. For instance, when WAIP is used for flat blocks, i.e. blocks with width greater than their height, some horizontal modes are replaced by extra vertical ones in the opposite direction beyond the antidiagonal mode #34 (−135-degree). Similarly, for tall blocks, i.e. blocks with height greater than their width, some vertical modes are replaced by extra horizontal ones in the opposite direction beyond the mode #2 (45 degree). FIG. 1 shows an exemplary case where modes #2 and #3 are replaced by #35 and #36, which were not considered in classical intra prediction. In order to support the additional prediction modes, the reference array on the longer side of the block is extended to twice the length of the side. On the other hand, the reference array on the shorter side is shortened to twice the length of the side since some modes originating from that side are removed.

The newly introduced modes are termed as wide angle modes. The modes beyond mode number #34 (−135 degree) are numbered in sequential order as #35, #36, and so on. Similarly, the newly introduced modes beyond mode #2 (45 degree) are numbered in sequential order as #1, #2, and so on. Modes #0 and #1 correspond to Planar and DC respectively, as in HEVC. It is to note that, in the current VVC, the number of intra prediction modes has been extended to 67 where modes #0 and #1 correspond to PLANAR and DC modes, and the remaining 65 modes correspond to directional modes. With WAIP, the number of directions has been extended to 85 with 10 extra directions each added beyond mode #66 (−135 degree) and mode #2 (45 degree). In this case, the modes added beyond mode #66 (−135 degree) are numbered in sequential order as #67, #68 . . . #76. Similarly, the modes added beyond mode #2 (45 degree) are numbered in sequential order as mode #−1, #−2, . . . #−10. Out of 85 directional modes, only 65 modes are considered for any given block. When the target block is a square, the directional modes remain unchanged. That is, the modes range from #2 to #66. When the target block is flat with width equal to twice the height, the directional modes range from #8 to #72. For all other flat blocks, that is, the blocks with width-to-height ratio greater than or equal to 4, the directional modes range from #12 to #76. Similarly, when the target block is tall with height equal to twice the width, the directional modes range from #−6 to #60. For all other tall blocks, that is, the blocks with height-to-width ratio greater than or equal to 4, the directional modes range from #−10 to #56. Since the total number of directional modes is still 65, the encoding of the mode index remains unchanged. That is, for the encoding purpose, a wide angle mode is indexed with the same index as the corresponding original mode in the opposite direction, which is removed. In other words, the wide angle modes are mapped to the original mode indices. For a given target block, this mapping is one-to-one, and therefore there is no discrepancy between the encoding followed by the encoder and the decoder.

When WAIP is used, the actual encoded intra prediction direction then corresponds to the opposite to the encoded intra prediction mode index, i.e. the coded mode index is not changed, the decoder derives the actual mode knowing the dimensions of the block. This has a consequence on other coding tools that depend on the prediction mode. In the general aspects described herein, we consider the impact on the selection of the set and the coding of the index of both the enhanced multiple transforms (EMT) and the non-separable secondary transforms (NSST).

Both EMT and NSST depend on the intra prediction mode. For instance, with EMT, there currently exists a table look-up that maps the intra mode to the proper transform ser. This table has the size of the number of intra modes, i.e. 67 in the current VVC. In each set of EMT, 4 pairs of horizontal and vertical transforms are predefined. For each prediction mode, an NSST set contains 3 offline learned transforms in addition to the identity transform (i.e., no NSST is applied). When WAIP is considered, the actual prediction mode can exceed the original maximum prediction mode index (#66) and can also have a negative value. As mentioned before, in the current design, up to 85 intra directions are considered. Therefore, in the case of a wide angle prediction mode, the mapping table that relates the prediction mode to the transform set cannot be used as is.

The general aspects described herein propose three ways to solve this problem:
1) Constant value extension. Whenever the prediction mode exceeds the maximum value (#66), the transform set corresponding maximum value prediction mode value (#66) is used. Similarly, when the prediction mode is negative, the transform set of the lowest angular prediction mode value (#2) is used.
2) Mirror Extension: for prediction modes beyond the maximum value or negative, the transform set corresponding to the opposite direction is used, and the pair of the horizontal and vertical are interchanged.
3) Extension with offline trained values: the dependency between the EMT and the prediction mode is learned through offline data. A similar procedure could be followed in order to learn the best sets for the new modes due to the usage of WAIP. Additionally, the NSST transform matrices could be learned for these modes and be added to the existing set.

Recently, it has been noticed that coding of the EMT index can be optimized by considering the prediction mode index. For example, the different CABAC contexts can be used for each prediction mode, or even for modes beyond and below the diagonal mode. In addition, different strategy could be used for coding horizontal, vertical and diagonal modes. When WAIP is used, the same problem, as in the previous section, occurs. This is because the actual prediction mode is not the same as the encoded one.

The general aspects described herein solve the problem in similar way as in the previous section. Namely, two solutions exist:
1—Constant value extension: Whenever the prediction mode exceeds the maximum value (#66), the coding of the transform set index considers the maximum value prediction mode value (#66), and when the prediction mode is negative, the coding of the transform set index considers the lowest angular prediction mode value (#2) is used.
2—Extension with new values: Whenever the prediction mode exceeds the maximum value (#66) or becomes negative, the coding of the transform set index takes these new values for CABAC context. Also, these new values can be used to distinguish horizontal, vertical and diagonal modes.
   In JEM software, the mapping between the intra prediction mode and transform set is described as follows:

For each prediction mode (from 0 to 66), a horizontal (g_aucTrSetHorz) and vertical (g_aucTrSetVert) mapping table is defined as:

```
g aucTrSetVert[67] =
{
  2, 1, 0, 1, 0, 1, 0, 1, 0, 1, 0, 1, 0, 1, 0, 0, 0, 0, 0, 0, 0, 0, 0, 1, 0, 1, 0, 1, 0, 1, 0, 1, 0, 1, 0, 1, 0, 1,
0, 1, 0, 1, 0, 1, 0, 1, 2, 2, 2, 2, 2, 2, 2, 2, 2, 1, 0, 1, 0, 1, 0, 1, 0, 1, 0, 1, 0
};
g_aucTrSetHorz[67] =
{
  2, 1, 0, 1, 0, 1, 0, 1, 0, 1, 0, 1, 0, 1, 2, 2, 2, 2, 2, 2, 2, 2, 2, 1, 0, 1, 0, 1, 0, 1, 0, 1, 0, 1, 0, 1, 0, 1,
0, 1, 0, 1, 0, 1, 0, 1, 0, 0, 0, 0, 0, 0, 0, 0, 0, 1, 0, 1, 0, 1, 0, 1, 0, 1, 0, 1, 0
};
```

This table provides the transform sub-set index in an array of 3 subset:

g_aiTrSubsetIntra[3][2]={{DST7,DCT8},{DST7,DCT2},{DST7,DCT2}};

for example, for the first mode (0), both the horizontal and vertical mapping tables have a value of 2 (g_aucTrSetVert[0]=2, g_aucTrSetVert[0]=2). This means both horizontal and vertical subsets will be {DST7,DCT8}.
As can be seen, this is an example of dependency between the intra mode and transform selection. When WAIP is used, the following solution can be used (constant value extension):

IntraMode_WAIP=GetIntraModeWAIP(IntraMode,BlkWidth,BlkHeight)

IntraMode_WAIP=maximum(minimum(2,IntraMode_WAIP),66)

Where IntraMode is the current intra prediction mode. IntraMode_WAIP is the corrected mode due to WAIP, which may contain values beyond 66 and below zero due to WAIP.
This value is obtained by the function GetintraModeWAIP that takes the block width (BlkWidth) and height (BlkHeight). Then, IntraMode_WAIP is clipped between 2 and 66. A recent contribution proposes to encode differently the transform set index for modes beyond the diagonal modes. Namely,

```
if (intraModeLuma < 35) {
    if (trIdx == 1) trIdx = 2;
    else if (trIdx == 2) trIdx = 1;
  }
  int nTrSubset = 0;
  if (intraModeLuma == 0) nTrSubset = 0;
  else if (intraModeLuma == 1) nTrSubset = 1;
  else if (intraModeLuma < 34) nTrSubset = 2;
  else nTrSubset = 3;
  m_BinEncoder.encodeBin(trIdx ? 1 : 0, Ctx::EMTTuIndex(0 + 3 * nTrSubset));
  if (trIdx) {
    m_BinEncoder.encodeBin((trIdx − 1) ? 1 : 0, Ctx::EMTTuIndex(1 + 3 *
nTrSubset));
    if (trIdx > 1) {
      m_BinEncoder.encodeBin((trIdx − 2) ? 1 : 0, Ctx::EMTTuIndex(2 + 3 *
nTrSubset));
    }
  }
```

When WAIP is applied, the only modification that is required to get the actual prediction mode in order to compare it with the diagonal mode.

Thus, the previous function should be proceeded by:

intraModeLuma=GetIntraModeWAIP(intraModeLuma,BlkWidth,BlkHeight)

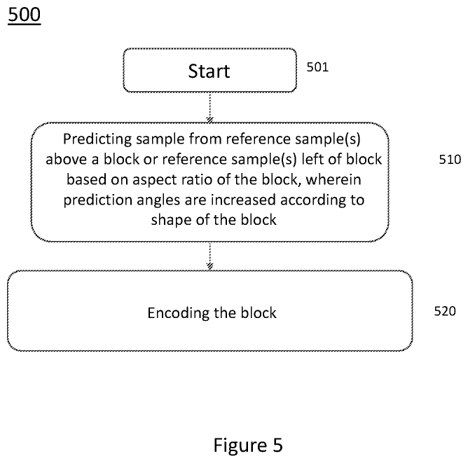

One embodiment of a method 500 under the general aspects described here is shown in FIG. 5. The method commences at start block 501 and control proceeds to block 510 for predicting a sample of a rectangular video block using at least one of N reference samples from a row above the rectangular video block or at least one of M reference samples from a column left of the rectangular video block, wherein a number of wide angles is increased in proportion to an aspect ratio of the rectangular block, wherein if a prediction mode for the rectangular video block is set to exceed a maximum prediction angle, a prediction mode is used corresponding to that maximum prediction angle. Control proceeds from block 510 to block 520 for encoding the rectangular video block using said prediction in an intra coding mode.

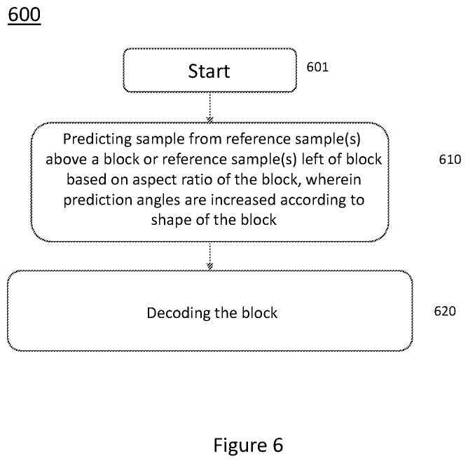

One embodiment of a method 600 under the general aspects described here is shown in FIG. 6. The method commences at start block 601 and control proceeds to block 610 for predicting a sample of a rectangular video block using at least one of N reference samples from a row above the rectangular video block or at least one of M reference samples from a column left of the rectangular video block, wherein a number of wide angles is increased in proportion to an aspect ratio of the rectangular block, wherein if a prediction mode for the rectangular video block is set to exceed a maximum prediction angle, a prediction mode is used corresponding to that maximum prediction angle. Control proceeds from block 610 to block 620 for decoding the rectangular video block using said prediction in an intra coding mode.

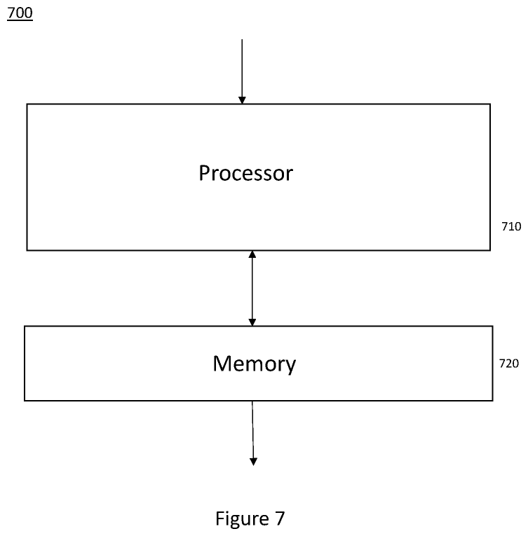

FIG. 7 shows one embodiment of an apparatus 700 for compressing, encoding or decoding video using improved virtual temporal affine candidates. The apparatus comprises Processor 710 and can be interconnected to a memory 720 through at least one port. Both Processor 710 and memory 720 can also have one or more additional interconnections to external connections.

Processor 710 is also configured to either insert or receive information in a bitstream and, either compressing, encoding or decoding using any of the described aspects.

This document describes a variety of aspects, including tools, features, embodiments, models, approaches, etc. Many of these aspects are described with specificity and, at least to show the individual characteristics, are often described in a manner that can sound limiting. However, this is for purposes of clarity in description, and does not limit the application or scope of those aspects. Indeed, all of the different aspects can be combined and interchanged to provide further aspects. Moreover, the aspects can be combined and interchanged with aspects described in earlier filings as well.

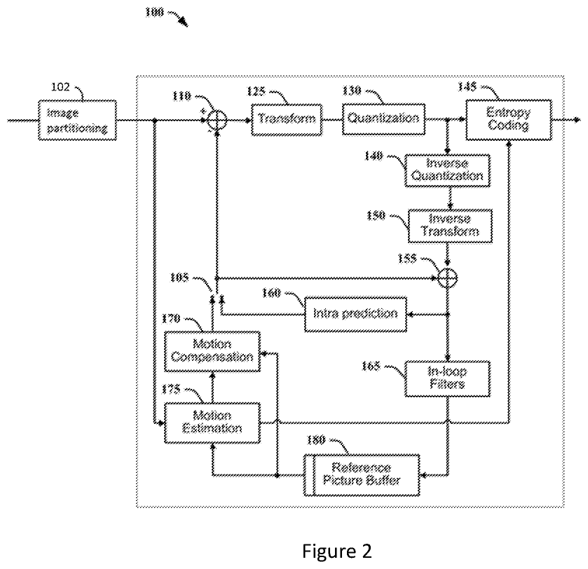

The embodiments described and contemplated in this document can be implemented in many different forms. FIGS. 2, 3 and 4 below provide some embodiments, but other embodiments are contemplated and the discussion of FIGS. 2, 3 and 4 does not limit the breadth of the implementations. At least one of the aspects generally relates to video encoding and decoding, and at least one other aspect generally relates to transmitting a bitstream generated or encoded. These and other aspects can be implemented as a method, an apparatus, a computer readable storage medium having stored thereon instructions for encoding or decoding video data according to any of the methods described, and/or a computer readable storage medium having stored thereon a bitstream generated according to any of the methods described.

In the present application, the terms “reconstructed” and “decoded” may be used interchangeably, the terms “pixel” and “sample” may be used interchangeably, the terms “image,” “picture” and “frame” may be used interchangeably. Usually, but not necessarily, the term “reconstructed” is used at the encoder side while “decoded” is used at the decoder side.

Various methods are described herein, and each of the methods comprises one or more steps or actions for achieving the described method. Unless a specific order of steps or actions is required for proper operation of the method, the order and/or use of specific steps and/or actions may be modified or combined.

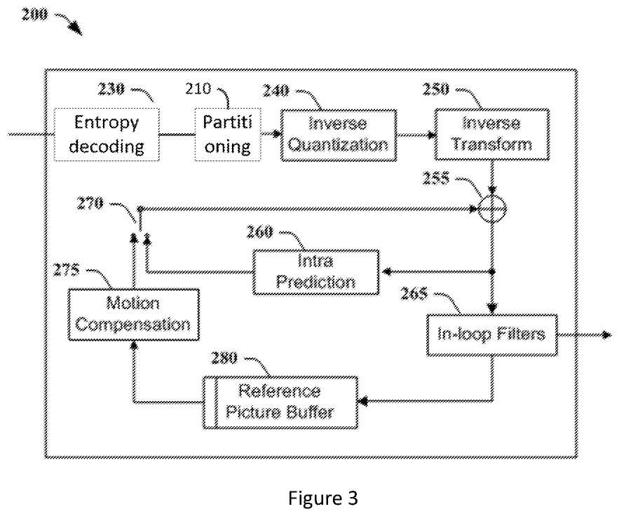

Various methods and other aspects described in this document can be used to modify modules, for example, the intra prediction, entropy coding, and/or decoding modules (160, 360, 145, 330), of a video encoder 100 and decoder 200 as shown in FIG. 2 and FIG. 3. Moreover, the present aspects are not limited to VVC or HEVC, and can be applied, for example, to other standards and recommendations, whether pre-existing or future-developed, and extensions of any such standards and recommendations (including VVC and HEVC). Unless indicated otherwise, or technically precluded, the aspects described in this document can be used individually or in combination.

Various numeric values are used in the present document, for example, {{1,0}, {3,1}, {1,1}}. The specific values are for example purposes and the aspects described are not limited to these specific values.

FIG. 2 illustrates an encoder 100. Variations of this encoder 100 are contemplated, but the encoder 100 is described below for purposes of clarity without describing all expected variations.

Before being encoded, the video sequence may go through pre-encoding processing (101), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of one of the color components). Metadata can be associated with the pre-processing and attached to the bitstream.

In the encoder 100, a picture is encoded by the encoder elements as described below. The picture to be encoded is partitioned (102) and processed in units of, for example, CUs. Each unit is encoded using, for example, either an intra or inter mode. When a unit is encoded in an intra mode, it performs intra prediction (160). In an inter mode, motion estimation (175) and compensation (170) are performed. The encoder decides (105) which one of the intra mode or inter mode to use for encoding the unit, and indicates the intra/inter decision by, for example, a prediction mode flag. Prediction residuals are calculated, for example, by subtracting (110) the predicted block from the original image block.

The prediction residuals are then transformed (125) and quantized (130). The quantized transform coefficients, as well as motion vectors and other syntax elements, are entropy coded (145) to output a bitstream. The encoder can skip the transform and apply quantization directly to the non-transformed residual signal. The encoder can bypass both transform and quantization, i.e., the residual is coded directly without the application of the transform or quantization processes.

The encoder decodes an encoded block to provide a reference for further predictions. The quantized transform coefficients are de-quantized (140) and inverse transformed (150) to decode prediction residuals. Combining (155) the decoded prediction residuals and the predicted block, an image block is reconstructed. In-loop filters (165) are applied to the reconstructed picture to perform, for example, deblocking/SAO (Sample Adaptive Offset) filtering to reduce encoding artifacts. The filtered image is stored at a reference picture buffer (180).

FIG. 3 illustrates a block diagram of a video decoder 200. In the decoder 200, a bitstream is decoded by the decoder elements as described below. Video decoder 200 generally performs a decoding pass reciprocal to the encoding pass as described in FIG. 2. The encoder 100 also generally performs video decoding as part of encoding video data.

In particular, the input of the decoder includes a video bitstream, which can be generated by video encoder 100. The bitstream is first entropy decoded (230) to obtain transform coefficients, motion vectors, and other coded information. The picture partition information indicates how the picture is partitioned. The decoder may therefore divide (235) the picture according to the decoded picture partitioning information. The transform coefficients are de-quantized (240) and inverse transformed (250) to decode the prediction residuals. Combining (255) the decoded prediction residuals and the predicted block, an image block is reconstructed. The predicted block can be obtained (270) from intra prediction (260) or motion-compensated prediction (i.e., inter prediction) (275). In-loop filters (265) are applied to the reconstructed image. The filtered image is stored at a reference picture buffer (280).

The decoded picture can further go through post-decoding processing (285), for example, an inverse color transform (e.g. conversion from YCbCr 4:2:0 to RGB 4:4:4) or an inverse remapping performing the inverse of the remapping process performed in the pre-encoding processing (101). The post-decoding processing can use metadata derived in the pre-encoding processing and signaled in the bitstream.

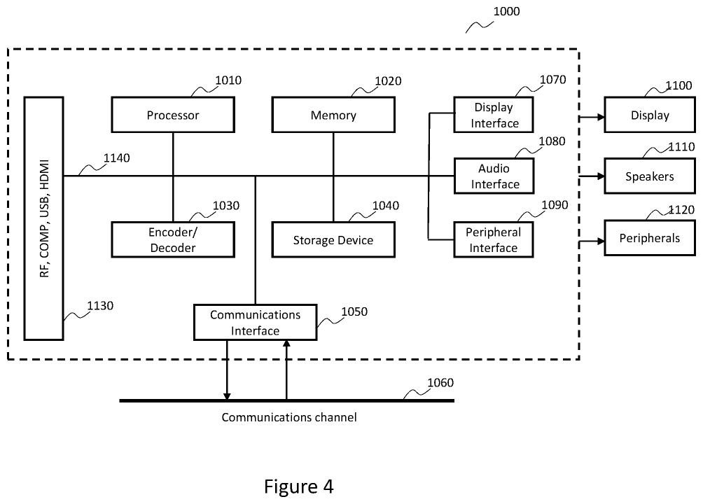

FIG. 4 illustrates a block diagram of an example of a system in which various embodiments are implemented. System 1000 can be embodied as a device including the various components described below and is configured to perform one or more of the aspects described in this document. Examples of such devices include, but are not limited to, various electronic devices such as personal computers, laptop computers, smartphones, tablet computers, digital multimedia set top boxes, digital television receivers, personal video recording systems, connected home appliances, and servers. Elements of system 1000, singly or in combination, can be embodied in a single integrated circuit, multiple ICs, and/or discrete components. For example, in at least one embodiment, the processing and encoder/decoder elements of system 1000 are distributed across multiple ICs and/or discrete components. In various embodiments, the system 1000 is communicatively coupled to other similar systems, or to other electronic devices, via, for example, a communications bus or through dedicated input and/or output ports. In various embodiments, the system 1000 is configured to implement one or more of the aspects described in this document.

The system 1000 includes at least one processor 1010 configured to execute instructions loaded therein for implementing, for example, the various aspects described in this document. Processor 1010 can include embedded memory, input output interface, and various other circuitries as known in the art. The system 1000 includes at least one memory 1020 (e.g., a volatile memory device, and/or a non-volatile memory device). System 1000 includes a storage device 1040, which can include non-volatile memory and/or volatile memory, including, but not limited to, EEPROM, ROM, PROM, RAM, DRAM, SRAM, flash, magnetic disk drive, and/or optical disk drive. The storage device 1040 can include an internal storage device, an attached storage device, and/or a network accessible storage device, as non-limiting examples.

System 1000 includes an encoder/decoder module 1030 configured, for example, to process data to provide an encoded video or decoded video, and the encoder/decoder module 1030 can include its own processor and memory. The encoder/decoder module 1030 represents module(s) that can be included in a device to perform the encoding and/or decoding functions. As is known, a device can include one or both of the encoding and decoding modules. Additionally, encoder/decoder module 1030 can be implemented as a separate element of system 1000 or can be incorporated within processor 1010 as a combination of hardware and software as known to those skilled in the art.

Program code to be loaded onto processor 1010 or encoder/decoder 1030 to perform the various embodiments described in this document can be stored in storage device 1040 and subsequently loaded onto memory 1020 for execution by processor 1010. In accordance with various embodiments, one or more of processor 1010, memory 1020, storage device 1040, and encoder/decoder module 1030 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In several embodiments, memory inside of the processor 1010 and/or the encoder/decoder module 1030 is used to store instructions and to provide working memory for processing that is needed during encoding or decoding. In other embodiments, however, a memory external to the processing device (for example, the processing device can be either the processor 1010 or the encoder/decoder module 1030) is used for one or more of these functions. The external memory can be the memory 1020 and/or the storage device 1040, for example, a dynamic volatile memory and/or a non-volatile flash memory. In several embodiments, an external non-volatile flash memory is used to store the operating system of a television. In at least one embodiment, a fast external dynamic volatile memory such as a RAM is used as working memory for video coding and decoding operations, such as for MPEG-2, HEVC, or VVC (Versatile Video Coding).

The input to the elements of system 1000 can be provided through various input devices as indicated in block 1130. Such input devices include, but are not limited to, (i) an RF portion that receives an RF signal transmitted, for example, over the air by a broadcaster, (ii) a Composite input terminal, (iii) a USB input terminal, and/or (iv) an HDMI input terminal.

In various embodiments, the input devices of block 1130 have associated respective input processing elements as known in the art. For example, the RF portion can be associated with elements for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which can be referred to as a channel in certain embodiments, (iv) demodulating the downconverted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, downconverting, and filtering again to a desired frequency band. Various embodiments rearrange the order of the above-described (and other) elements, remove some of these elements, and/or add other elements performing similar or different functions. Adding elements can include inserting elements in between existing elements, for example, inserting amplifiers and an analog-to-digital converter. In various embodiments, the RF portion includes an antenna.

Additionally, the USB and/or HDMI terminals can include respective interface processors for connecting system 1000 to other electronic devices across USB and/or HDMI connections. It is to be understood that various aspects of input processing, for example, Reed-Solomon error correction, can be implemented, for example, within a separate input processing IC or within processor 1010. Similarly, aspects of USB or HDMI interface processing can be implemented within separate interface ICs or within processor 1010. The demodulated, error corrected, and demultiplexed stream is provided to various processing elements, including, for example, processor 1010, and encoder/decoder 1030 operating in combination with the memory and storage elements to process the datastream for presentation on an output device.

Various elements of system 1000 can be provided within an integrated housing, Within the integrated housing, the various elements can be interconnected and transmit data therebetween using suitable connection arrangement 1140, for example, an internal bus as known in the art, including the 12C bus, wiring, and printed circuit boards.

The system 1000 includes communication interface 1050 that enables communication with other devices via communication channel 1060. The communication interface 1050 can include, but is not limited to, a transceiver configured to transmit and to receive data over communication channel 1060. The communication interface 1050 can include, but is not limited to, a modem or network card and the communication channel 1060 can be implemented, for example, within a wired and/or a wireless medium.

Data is streamed to the system 1000, in various embodiments, using a wireless network, such as IEEE 802.11. The wireless signal of these embodiments is received over the communications channel 1060 and the communications interface 1050 which are adapted for Wi-Fi communications, for example. The communications channel 1060 of these embodiments is typically connected to an access point or router that provides access to outside networks including the Internet for allowing streaming applications and other over-the-top communications. Other embodiments provide streamed data to the system 1000 using a set-top box that delivers the data over the HDMI connection of the input block 1130. Still other embodiments provide streamed data to the system 1000 using the RF connection of the input block 1130.

The system 1000 can provide an output signal to various output devices, including a display 1100, speakers 1110, and other peripheral devices 1120. The other peripheral devices 1120 include, in various examples of embodiments, one or more of a stand-alone DVR, a disk player, a stereo system, a lighting system, and other devices that provide a function based on the output of the system 1000. In various embodiments, control signals are communicated between the system 1000 and the display 1100, speakers 1110, or other peripheral devices 1120 using signaling such as AV.Link, CEC, or other communications protocols that enable device-to-device control with or without user intervention. The output devices can be communicatively coupled to system 1000 via dedicated connections through respective interfaces 1070, 1080, and 1090. Alternatively, the output devices can be connected to system 1000 using the communications channel 1060 via the communications interface 1050. The display 1100 and speakers 1110 can be integrated in a single unit with the other components of system 1000 in an electronic device, for example, a television. In various embodiments, the display interface 1070 includes a display driver, for example, a timing controller (T Con) chip.

The display 1100 and speaker 1110 can alternatively be separate from one or more of the other components, for example, if the RF portion of input 1130 is part of a separate set-top box. In various embodiments in which the display 1100 and speakers 1110 are external components, the output signal can be provided via dedicated output connections, including, for example, HDMI ports, USB ports, or COMP outputs.

Embodiments can be carried out by computer software implemented by the processor 1010 or by hardware, or by a combination of hardware and software. As a non-limiting example, the embodiments can be implemented by one or more integrated circuits. The memory 1020 can be of any type appropriate to the technical environment and can be implemented using any appropriate data storage technology, such as optical memory devices, magnetic memory devices, semiconductor-based memory devices, fixed memory, and removable memory, as non-limiting examples. The processor 1010 can be of any type appropriate to the technical environment, and can encompass one or more of microprocessors, general purpose computers, special purpose computers, and processors based on a multi-core architecture, as non-limiting examples.

Various implementations involve decoding. “Decoding”, as used in this application, can encompass all or part of the processes performed, for example, on a received encoded sequence in order to produce a final output suitable for display. In various embodiments, such processes include one or more of the processes typically performed by a decoder, for example, entropy decoding, inverse quantization, inverse transformation, and differential decoding. In various embodiments, such processes also, or alternatively, include processes performed by a decoder of various implementations described in this application, for example, extracting an index of weights to be used for the various intra prediction reference arrays.

As further examples, in one embodiment “decoding” refers only to entropy decoding, in another embodiment “decoding” refers only to differential decoding, and in another embodiment “decoding” refers to a combination of entropy decoding and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence in order to produce an encoded bitstream. In various embodiments, such processes include one or more of the processes typically performed by an encoder, for example, partitioning, differential encoding, transformation, quantization, and entropy encoding. In various embodiments, such processes also, or alternatively, include processes performed by an encoder of various implementations described in this application, for example, weighting of intra prediction reference arrays.

As further examples, in one embodiment “encoding” refers only to entropy encoding, in another embodiment “encoding” refers only to differential encoding, and in another embodiment “encoding” refers to a combination of differential encoding and entropy encoding. Whether the phrase “encoding process” is intended to refer specifically to a subset of operations or generally to the broader encoding process will be clear based on the context of the specific descriptions and is believed to be well understood by those skilled in the art.

Note that the syntax elements as used herein are descriptive terms. As such, they do not preclude the use of other syntax element names.

When a figure is presented as a flow diagram, it should be understood that it also provides a block diagram of a corresponding apparatus. Similarly, when a figure is presented as a block diagram, it should be understood that it also provides a flow diagram of a corresponding method/process.

Various embodiments refer to rate distortion calculation or rate distortion optimization. In particular, during the encoding process, the balance or trade-off between the rate and distortion is usually considered, often given the constraints of computational complexity. The rate distortion optimization is usually formulated as minimizing a rate distortion function, which is a weighted sum of the rate and of the distortion. There are different approaches to solve the rate distortion optimization problem. For example, the approaches may be based on an extensive testing of all encoding options, including all considered modes or coding parameters values, with a complete evaluation of their coding cost and related distortion of the reconstructed signal after coding and decoding. Faster approaches may also be used, to save encoding complexity, in particular with computation of an approximated distortion based on the prediction or the prediction residual signal, not the reconstructed one. Mix of these two approaches can also be used, such as by using an approximated distortion for only some of the possible encoding options, and a complete distortion for other encoding options. Other approaches only evaluate a subset of the possible encoding options. More generally, many approaches employ any of a variety of techniques to perform the optimization, but the optimization is not necessarily a complete evaluation of both the coding cost and related distortion.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this document are not necessarily all referring to the same embodiment.

Additionally, this document may refer to “determining” various pieces of information. Determining the information can include one or more of, for example, estimating the information, calculating the information, predicting the information, or retrieving the information from memory.

Further, this document may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this document may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in certain embodiments the encoder signals a particular one of a plurality of weights to be used for intra prediction reference arrays. In this way, in an embodiment the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

The preceding description has described a number of embodiments. These and further embodiments include the following optional features alone or in any combination, across various different claim categories and types:
Using prediction directions during intra prediction in encoding and decoding beyond −135 degrees and 45 degrees
extending interactions between wide-angle modes and PDPC
extending the prediction directions in a horizontal or vertical direction while removing some directions in the opposite direction to maintain the same number of total directions
extending the number of directions both beyond −135 degrees and beyond 45 degrees
combining PDPC and wide angle intra prediction to samples within a block
signaling from an encoder to a decoder which prediction directions are being used
using a subset of prediction directions
the block is a CU having a rectangular shape
the other block is a neighboring block
A bitstream or signal that includes one or more of the described syntax elements, or variations thereof.
Inserting in the signaling syntax elements that enable the decoder to process a bitstream in an inverse manner as to that performed by an encoder.
Creating and/or transmitting and/or receiving and/or decoding a bitstream or signal that includes one or more of the described syntax elements, or variations thereof.
A TV, set-top box, cell phone, tablet, or other electronic device that performs any of the embodiments described.
A TV, set-top box, cell phone, tablet, or other electronic device that performs any of the embodiments described, and that displays (e.g. using a monitor, screen, or other type of display) a resulting image.
A TV, set-top box, cell phone, tablet, or other electronic device that tunes (e.g. using a tuner) a channel to receive a signal including an encoded image, and performs any of the embodiments described.
A TV, set-top box, cell phone, tablet, or other electronic device that receives (e.g. using an antenna) a signal that includes an encoded image, and performs any of the embodiments described.
Various other generalized, as well as particularized, features are also supported and contemplated throughout this disclosure.

1. A method, comprising:
predicting a sample of a rectangular video block using at least one of N reference samples from a row above the rectangular video block or at least one of M reference samples from a column left of the rectangular video block, wherein a number of wide angles is increased in proportion to an aspect ratio of the rectangular block, wherein if a prediction mode for the rectangular video block is set to exceed a maximum prediction angle, a prediction mode is used corresponding to that maximum prediction angle; and,
encoding the rectangular video block using said prediction in an intra coding mode.

2. An apparatus, comprising:
a processor, configured to:
predict a sample of a rectangular video block using at least one of N reference samples from a row above the rectangular video block or at least one of M reference samples from a column left of the rectangular video block, wherein a number of wide angles is increased in proportion to an aspect ratio of the rectangular block, wherein if a prediction mode for the rectangular video block is set to exceed a maximum prediction angle, a prediction mode is used corresponding to that maximum prediction angle; and,
encode the rectangular video block using said prediction in an intra coding mode.

3. A method, comprising:
predicting a sample of a rectangular video block using at least one of N reference samples from a row above the rectangular video block or at least one of M reference samples from a column left of the rectangular video block, wherein a number of wide angles is increased in proportion to an aspect ratio of the rectangular block, wherein if a prediction mode for the rectangular video block is set to exceed a maximum prediction angle, a prediction mode is used corresponding to that maximum prediction angle; and,
decoding the rectangular video block using said prediction in an intra coding mode.

4. An apparatus, comprising:
a processor, configured to:
predict a sample of a rectangular video block using at least one of N reference samples from a row above the rectangular video block or at least one of M reference samples from a column left of the rectangular video block, wherein a number of wide angles is increased in proportion to an aspect ratio of the rectangular block, wherein if a prediction mode for the rectangular video block is set to exceed a maximum prediction angle, a prediction mode is used corresponding to that maximum prediction angle; and,
decode the rectangular video block using said prediction in an intra coding mode.

5. The method of claim 3, wherein wide angles exceeding −135 degrees and 45 degrees are used.

6. The method of claim 3, wherein position dependent intra prediction combination is used with wide angle intra prediction.

7. The method of claim 3, wherein prediction directions for wide angle intra prediction are extended in a horizontal or vertical direction while removing a corresponding number of angles in an opposite direction to maintain a same number of total angles.

8. The method of claim 3, wherein a number of prediction angles exceed −135 degrees or exceed 45 degrees.

9. The method of claim 3, wherein position dependent intra prediction combination is combined with wide angle intra prediction and applied to samples within a block.

10. The method of claim 3, wherein said block is a coding unit having a rectangular shape.

11. The method of claim 3, wherein reference samples being used are from a neighboring block.

12. A device comprising:
an apparatus according to claim 4; and
at least one of (i) an antenna configured to receive a signal, the signal including the video block, (ii) a band limiter configured to limit the received signal to a band of frequencies that includes the video block, and (iii) a display configured to display an output representative of a video block.

13. A non-transitory computer readable medium containing data content generated according to the method of any one of claim 1, for playback using a processor.

14. A computer program product comprising instructions which, when the program is executed by a computer, cause the computer to carry out the method of any one of claim 1, for playback using a processor.

15. A computer program product comprising instructions which, when the program is executed by a computer, cause the computer to carry out the method of any one of claim 3.
